(19) United States
(12) Patent Application Publication
(10) Pub. No.: US 2002/0058561 A1
(43) Pub. Date: May 16, 2002

(54) Silent chain

(75) Inventors: Makoto Kanehira, Osaka-shi (JP); Kazumasa Matsuno, Osaka-shi (JP); Hitoshi Ohara, Osaka-shi (JP); Shigekazu Fukuda, Osaka-shi (JP); Hiroshi Horie, Osaka-shi (JP); Takayuki Funamoto, Osaka-shi (JP); Yoshihiro Kusunoki, Osaka-shi (JP); Masao Maruyama, Osaka-shi (JP)

Correspondence Address: ARMSTRONG,WESTERMAN & HATTORI, LLP, 1725 K STREET, NW., SUITE 1000, WASHINGTON, DC, 20006, US

(73) Assignee: TSUBAKIMOTO CHAIN CO., Osaka (JP)

(21) Appl. No.: 09/505,064

(22) Filed: Feb. 16, 2000

(30) Foreign Application Priority Data
Feb. 18, 1999 (JP) 11-40619/1999

(51) Int. Cl. F16G 13/04

(52) U.S. Cl. 474/213; 474/212

(57) ABSTRACT

A silent chain for use with a driving or driven sprocket includes a plurality of link plates each having a pair of teeth engageable with teeth of the sprocket. In each of the link plates, the teeth have a pair of symmetric outside flanks that are caused to be seated on corresponding teeth of the sprocket when the teeth of the link plate are placed in full meshing engagement with the corresponding sprocket teeth, and a pair of symmetric inside flanks each having an arcuately convex profile protruding toward the other inside flank in such a manner that a leading one of the inside flanks of the link plate interferes with one of the corresponding teeth of the sprocket at the onset of the meshing engagement between the link plate and the corresponding sprocket teeth. These link plates are interconnected serially, by a plurality of pivot pins, into a longitudinally articulated strand. The outside flanks of each of the link plates are shaped into any one of two or more different profiles, and the link plates having the respective outside flanks formed into the two or more different profiles are arranged irregularly in a random mixture in the longitudinal direction of the silent chain in such a manner that the link plates mesh with the sprocket at different radial positions of the sprocket teeth depending on the profiles of their outside flanks.

### BACKGROUND OF THE INVENTION

1. Field of the Invention

The present invention relates to silent chains which are constructed to reduce undesired noise or meshing sounds that would occur when they mesh with teeth of a driving or driven sprocket.

2. Related Prior Art

Today, silent chains are being used extensively for a variety of purposes, such as power transmission between an engine crankshaft and camshaft in an automotive vehicle. These silent chains include a plurality of rows of link plates serially interconnected or articulated with each other, and each of the link plates is in a virtually bifurcated or V shape to provide, at its opposite ends, a pair of meshing teeth which are directly meshable with successive teeth of a sprocket wheel. More specifically, outside or inside flanks of these teeth are sequentially brought into a power-transmitting contact with the sprocket teeth.

Various improvements have been made so far in these silent chains to reduce undesired noise or meshing sounds that would occur during their power-transmitting meshing operation. For example, Japanese Patent Laid-open Publication No. HEI-3-51933 discloses one improved silent chain where two different types of link plates are interlaced in a random mixture; each link plates of one of the two types meshes with the sprocket teeth along its inside flanks while each link plate of the other type meshes with the sprocket teeth along its outside flanks. Such mixed arrangement of the different types of link plate acts to disperse or randomize the generation cycles of the meshing-sound resulting from the sequential meshing contact between the link plates and the sprocket teeth to promote cancellation of the peak meshing sounds, thereby preventing the meshing sounds from resonating to get louder.

Further, in Japanese Utility Model Publication No. HEI 8-1312, there is disclosed another improved silent chain which is designed to reduce the meshing noise level by suppressing the meshing sound resonance in a similar manner to the one disclosed in Japanese Patent Laid-open Publication No. HEI-3-51933. More specifically, in the silent chain disclosed in this utility model publication, its principal composite-profile link plates are designed to mesh with the sprocket teeth along their outside flanks, each of which has a continuously curved composite surface made up of concave and convex arcs. The concave arc of the outside flank has a radius of curvature generally equal to that in a meshing area of each of the sprocket teeth while the convex ark of the outside flank has its center of curvature offset from the link's meshing pitch line toward the tooth root to produce a slight interference with the sprocket tooth. These principal link plates are interleaved with straight-profile link plates having a meshing pitch different from that of the principal link plates and each having straight meshing tooth surfaces, as well as auxiliary composite-profile link plates having a meshing pitch different from that of the principal link plates but having the same shape as the principal link plates.

The silent chain discussed in Japanese Patent Laid-open Publication No. HEI-3-51933 can effectively randomize the generation cycles of the meshing sounds to avoid the sound resonance; however, it would fail to attain a sufficient noise reduction since it is not so designed as to damp the collision between the meshing tooth surfaces of the link plates and the sprocket teeth.

Further, according to the silent chain discussed in Japanese Utility Model Publication No. HEI-8-1312, the arcuately convex surfaces of the outside flanks in the principal and auxiliary composite-profile link plates are caused to interfere with and then slide along the sprocket teeth in order to damp an impact of initial hard contact or collision against the sprocket teeth at the onset of the meshing engagement therewith. However, because the convex arcs of the outside flanks are each formed as part of the continuously curved composite surface which also includes the concave arc, it can not have a sufficient length to effectively buffer the collision against the sprocket teeth. In addition, because the inside flanks do not take part in the meshing engagement and damping of the collision impact at all, the outside flanks would unavoidably hard hit the sprocket teeth at the beginning of the meshing engagement with the sprocket teeth, thereby causing greater meshing sounds.

### SUMMARY OF THE INVENTION

In view of the foregoing prior art problems, it is an object of the present invention to provide a silent chain which can minimize undesired meshing sounds or noise produced by meshing engagement between the silent chain and a sprocket.

In order to accomplish the above-mentioned object, the present invention provides a silent chain for use with a sprocket, which includes a plurality of link plates each having a pair of spaced meshing teeth engageable with teeth of the sprocket. The teeth of each of the link plates have a pair of symmetric outside flanks that are caused to be seated on corresponding sprocket teeth when the meshing teeth of the link plate are placed in full meshing engagement with the corresponding sprocket teeth, and a pair of symmetric inside flanks each having an arcuately convex profile protruding toward the other inside flank of the link plate in such a manner that a leading one of the two inside flanks of the link plate interferes with one of the corresponding teeth of the sprocket at the onset of the meshing engagement between the link plate and the corresponding teeth of the sprocket. These link plates are interconnected serially, by means of a plurality of pivot pins, into a longitudinally articulated strand. In the silent chain of the present invention, the outside flanks of each of the link plates are shaped into any one of two or more different profiles, and the link plates having the respective outside flanks shaped into these two or more different profiles are arranged irregularly in a random mixture in the longitudinal direction of the silent chain in such a manner that the link plates mesh with the sprocket at different radial positions of the sprocket teeth depending on the profiles of the outside flanks.

In a preferred implementation, the outside flanks of some of the link plates each have a straight profile and the outside flanks of the remaining link plates each have a continuously curved composite profile of concave and convex arcs.

In response to rotation of a driving sprocket, for example, a silent chain link plate on the point of coming into meshing engagement with the sprocket teeth (i.e., “about-to-mesh link plate”) is caused to pivot about a connector pin inserted through a trailing tooth of a laterally adjacent link plate, slightly preceding the about-to-mesh link plate, whose outside flanks of the two meshing teeth have already been completely seated on the sprocket teeth. Thus, the inside flank of the leading tooth of the link plate and the inside flank of the leading tooth of another laterally adjacent plate slightly succeeding the about-to-mesh link plate sequentially interfere with and then slide along the sprocket teeth. At that time, frictional resistance produced between the inside flanks of these successive link plates and the sprocket teeth can effectively damp the impact of collision that would be produced when the link plates are brought into meshing engagement with the sprocket teeth and thereby suppress generation of the undesired meshing sounds.

As the silent chain advances further due to the rotation of the sprocket, the about-to-mesh link plate is caused to pivot further, about the connector pin shared with the already-seated preceding link plate, so that the inside flank of the leading tooth of the link plate leaves the sprocket tooth and then the outside flank of the same meshing tooth is seated on the succeeding sprocket tooth.

Immediately before the about-to-mesh plate is completely seated on the sprocket teeth, the succeeding plate, having so far interfered at the inside flank of its leading tooth with the sprocket tooth, is caused to retract the inside flank rearwardly (as viewed in the advancing direction of the chain) of the outside flank of the trailing tooth of the preceding plate, due to its pivoting movement about the connector pin shared with the about-to-mesh link plate, so that the interference with the sprocket tooth is lost and the outside flank of the trailing tooth of the about-to-mesh link plate is seated on the succeeding sprocket tooth.

According to the present invention thus constructed, repetition of the above-mentioned operational sequence allows the respective outside flanks of the plates, serially connected via the connector pins, to be sequentially seated on the sprocket teeth. In this invention, the link plates can mesh with the sprocket at different radial positions of the sprocket teeth depending on the profiles of their outside flanks. Namely, the radial position on the sprocket teeth with which the chain's outside flanks mesh is allowed to vary, in the longitudinal direction of the chain, between the link plates having the differently-profiled outside flanks, which would cause the periodicity of the generated meshing sounds to differ variously and thereby can reduce the overall noise level. Particularly, by irregularly arranging the link plates, having their outside flanks formed into two different profiles, in a random mixture in the longitudinal direction of the silent chain, the present invention can effectively prevent generation of meshing sounds of a resonating periodicity, thereby minimizing the overall noise level.

### BRIEF DESCRIPTION OF THE DRAWINGS

Certain preferred embodiments of the present invention will be described in greater detail with reference to the accompanying sheets of drawings, in which:

FIG. 1 is a fragmentary side view of a silent chain in accordance with a preferred embodiment of the present invention;

FIG. 2 is a fragmentary top plan view, partly in cross section, of the silent chain shown in FIG. 1;

FIGS. 3A and 3B are views illustrating two different symmetric profiles of outside flanks of link plates in the silent chain of FIG. 1; and

FIGS. 4 and 5 are enlarged fragmentary views explanatory of an exemplary operational sequence in which the link plates of the inventive silent chain sequentially mesh with sprocket teeth.

### DETAILED DESCRIPTION OF THE PREFERRED EMBODIMENTS

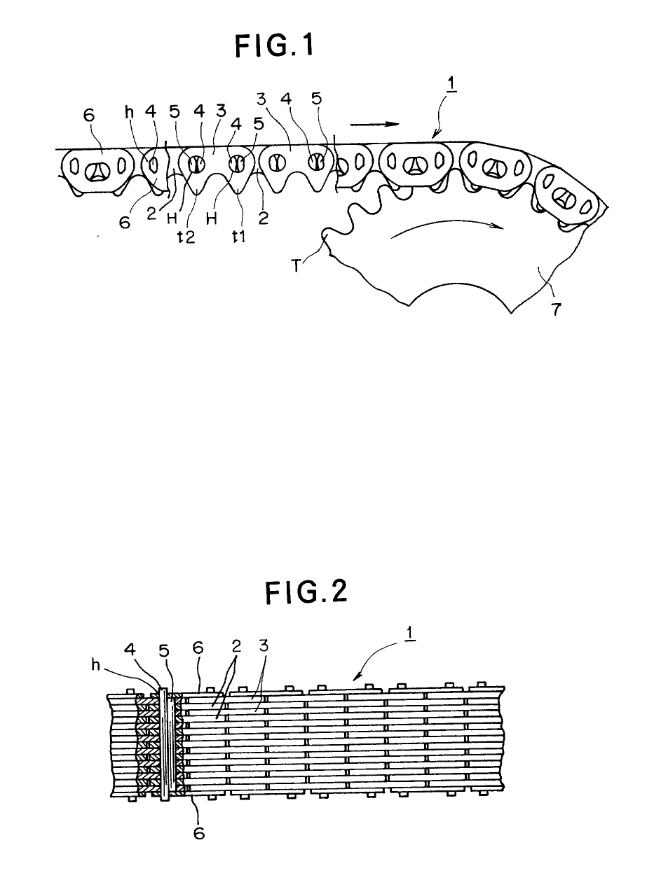

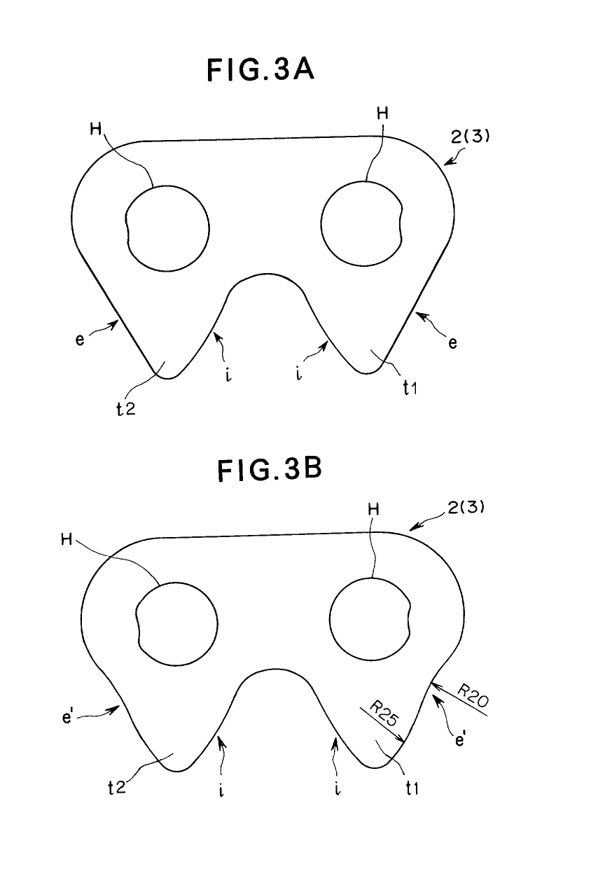

FIG. 1 is a fragmentary side view of a silent chain in accordance with a preferred embodiment of the present invention, and FIG. 2 is a fragmentary top plan view, partly in section, of the silent chain of FIG. 1. As shown, the silent chain 1 comprises longitudinal rows of guide link plates (or first link plates) 2 and articulation link plates (or second link plates) 3, and the rows of guide link plates 2 are spaced from each other, in the widthwise or transverse direction of the silent chain 1, by the rows of articulation link plates 3. Specifically, each of the component link plates 2 and 3 of the silent chain 1 has a virtually bifurcated or V-shaped configuration to provide a pair of spaced meshing teeth and has two pin holes as will be later described. In the widthwise or transverse direction of the silent chain 1, the rows of the link plates 2 and link plates 3 are stacked closely, in an alternate fashion, with each of the link plates 2 or 3 having leading (fore) and trailing (rear) halves overlapping those of the laterally-adjacent link plates 3 or 2 so that the pin holes H of these overlapping plates are aligned with each other. These rows of the link plates 2 and 3 are connected by means of pairs of cross rocker-joint pins 4 and 5, each of the pairs inserted through the pin holes H of the overlapping link plates 2 and 3, so as to provide a closed (endless) loop flexible along the length of the silent chain 1. In each of the rocker-joint pin pairs, the pin 4 is longer in length than the other pin 5, and these pins 4 and 5 are each secured in place by being fitted at their opposite ends in pin holes h formed in a pair of outside guide plates 6 that are disposed on both outsides of the silent chain 1. On each of the outsides of the silent chain 1, a plurality of such outside guide plates 6 are provided, in a slightly-spaced relation to each other, along the length of the chain 1. This way, each pair of the outside guide plates 6 retains a corresponding set of the stacked link plates 2 and 3 in a side-by-side link block, in conjunction with the corresponding rocker-joint pins 4 and 5 inserted through the link plates 2 and 3.

When the silent chain 1 are meshing with teeth T of a driving or driven sprocket 7, the outside guide plates 6 function to allow the guide link plates 2 to be properly guided along their side surfaces by the sprocket teeth T while reliably preventing the silent chain 1 from being accidentally detached laterally from the sprocket 7. Driving power is transmitted from the silent chain 1 to the sprocket 7 or vice versa through sequential meshing engagement between the meshing teeth t1, t2 of the link plates 2 and 3 and the teeth T of the sprocket, as will be detailed later.

Because the outside guide plates 6 disposed on both outsides of the silent chain 1 are laterally aligned with the guide link plates 2 while they are offset a half pitch from the articulation link plates 3 in the longitudinal direction of the silent chain 1 as shown in FIG. 2, the articulation link plates 3 may be formed to have a slightly greater thickness than the guide link plates 2 in such a manner that the silent chain 1 can assume a uniform physical strength both at the positions of the guide link plates 2 and at the positions of the articulation link plates 3.

In the illustrated example, all the guide link plates 2 retained in the same side-by-side link block, i.e., packaged side by side via the same pair of the outside guide plates 6, are identical in the profile of the meshing teeth t1 and t2, and all the articulation link plates 3 packaged side by side via two adjacent pairs of the outside guide plates 6 are also identical in the profile of the meshing teeth t1 and t2. However, in each of the longitudinal rows of the guide link plates 2 and articulation link plates 3, the meshing teeth t1 and t2 of the link plates 2 or 3 have two different symmetric profiles so that the link plates 2 and 3, each having an optionally selected one of the two different teeth profiles (i.e., differing in the type of the teeth profile), are mixedly arranged in the longitudinal direction of the silent chain 1.

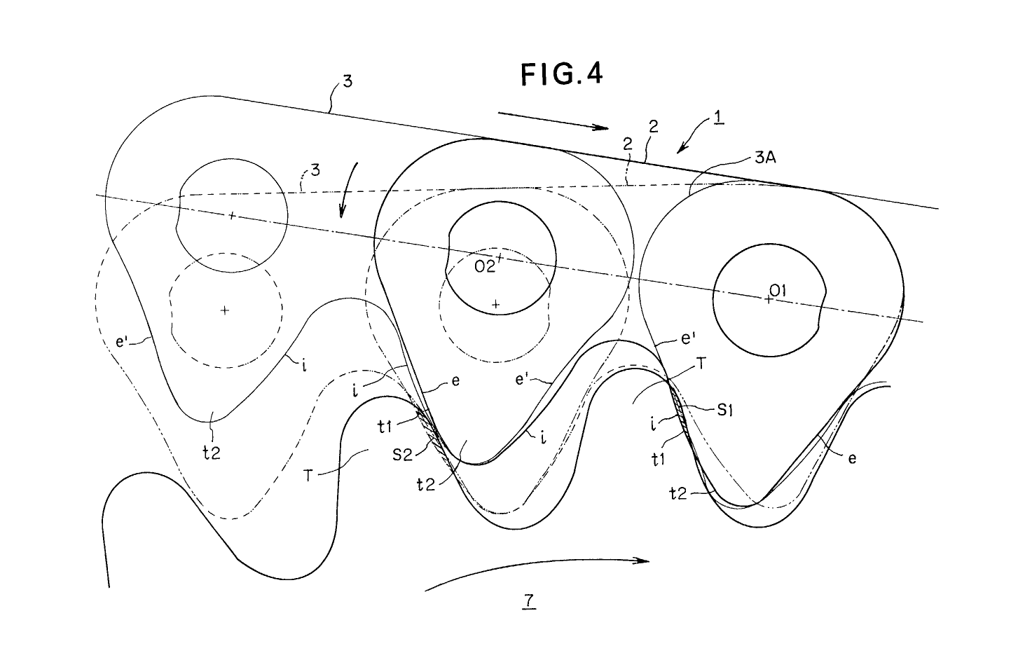

More specifically, FIG. 3A illustrates one of such two different symmetric profiles (namely, first-type link plate 2 or 3), where the meshing teeth t1 and t2 each have a straight outside flank e and an arcuately convex inside flank i arcuately protruding to the inside flank i of the other meshing tooth.

Further, FIG. 3B illustrates the other symmetric profile (namely, second-type link plate 2 or 3), where the meshing teeth t1 and t2 each have a continuous gently-curved outside flank e′ with a continuous composite surface of convex and concave arcs and an arcuately-convex inside flank i similar to the one in the first-type link plate of FIG. 3A.

Most preferably, each of the guide link plates 2 and articulation link plates 3 employed in the preferred embodiment is sized such that a pitch between the centers of the pin holes H is 9.46 mm, and a radius of curvature of the arcuately convex inside flank i is 14.9 mm. Particularly, in each of the second-type link plate 2 or 3 as illustratively shown in FIG. 3B, radii of curvature of the convex and concave arcs of the outside flank e′ are chosen to be 20 mm and 25 mm, respectively.

Further, the guide link plates 2 and articulation link plates 3, having the above-mentioned two different teeth profiles, are designed to mesh with the sprocket teeth T along their respective outside flanks e and e′, and the arcuately convex inside flanks i of these first- and second-type link plates 2 and 3 are configured so as to interfere with the sprocket teeth T only at the onset of the meshing engagement therewith for purposes to be described later.

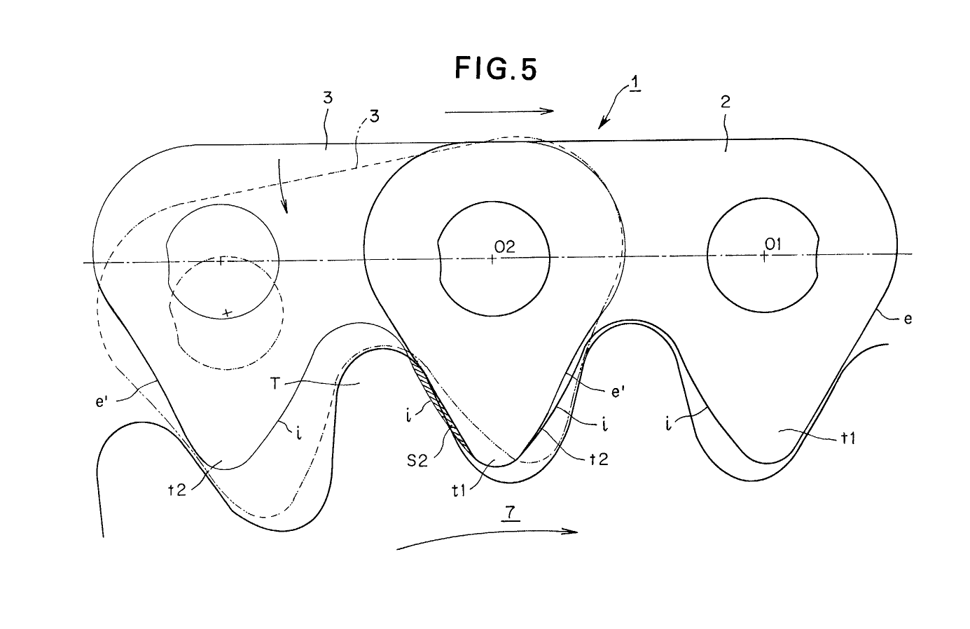

FIGS. 4 and 5 are fragmentary views illustrating how the above-described silent chain 1 meshes with the driving or driven sprocket 7. In these figures, the guide link plate 2 depicted as being on the point of coming into meshing engagement with the sprocket 7 (hereinafter also referred to as an “about-to-mesh link plate”) is of the first type having the outside flanks e formed into a straight profile as shown in FIG. 3A, and the articulation link plate 3 depicted as slightly succeeding the guide link plate 2, which, in effect, is laterally adjacent the about-to-mesh link plate 2 (i.e., not in the same row as the link plate 2), is of the second type having the outside flanks e′ formed to provide a continuous composite profile of concave and convex arcs as shown in FIG. 3B. Further, the articulation link plate 3A depicted as slightly preceding the guide link plate 2, which is also laterally adjacent the about-to-mesh link plate 2 (i.e., not in the same row as the link plate 2), is of the second type having the outside flanks e′ formed to provide a continuous composite profile of concave and convex arcs in just the same manner as the succeeding articulation plate 3.

It is important to note that in the preferred embodiment of the present invention, the guide link plates 2 and articulation link plates 3, whose respective outside flanks have the above-mentioned two different profiles, are arranged in a random or irregular fashion, rather than in a regular alternate fashion as found in some of the prior art silent chains, so that the two different profiles of the outside flanks, i.e., the first- and second-type link plates 2 and 3, occur irregularly in a random mixture along the length of the silent chain 1.

For example, as the sequential power-transmitting engagement progresses between the silent chain 1 and the sprocket 7 in the illustrated example of FIG. 4, the about-to-mesh link plate 2, depicted as being on the point of coming into meshing engagement with the sprocket teeth T, is caused to pivot, about the center O1 of one of the pin holes H, relative to the link plate 3A whose outside flanks e have been almost completely seated on the sprocket teeth T slightly ahead of the about-to-mesh link plate 2, so that the two meshing teeth t1 and t2 of the link plate 2 are each introduced into between the successive teeth T of the sprocket 7.

Also note that because the link plates 2 and 3 (3A) overlapping each other side by side are connected together by pairs of the cross rocker-joint pins 4 and 5 inserted through the pin hole H as previously mentioned, the center O1 of each of the pin holes H corresponds substantially to a contact point between the rocker-joint pins 4 and 5 and hence will also be called a “pin connection point”.

As shown by solid lines in FIG. 4, at the onset of the meshing engagement when the about-to-mesh link plate 2 is at substantially the same rotational angle as, i.e., or horizontally parallel to, the preceding link plate 3A having been almost completely seated on the sprocket teeth T ahead of the link plate 2, the inside flank i of the leading tooth t1 of the about-to-mesh link plate 2 projects slightly beyond the outside flank e′ of the trailing teeth t2 of the preceding link plate 3A to thereby interfere with one tooth T of the sprocket 7 at a buffer region S1 depicted by hatching for clarity in FIG. 4.

Such interference of the inside flank i with the sprocket tooth T can effectively damp or buffer an impact that would occur as the outside flank e′ of the trailing teeth t2 of the preceding plate 3A contacts and gets seated on the sprocket tooth T.

In more specific terms, as the about-to-mesh link plate 2 pivots (in a counterclockwise direction as arrowed in the figure) about the pin connection point 01, shared with the preceding link plate 3, from the solid-line position to the phantom-line position in FIG. 4, the arcuately convex inside flank i of the leading tooth t1 of the link plate 2, having so far interfered with the sprocket tooth T in the buffer region S1, moves forward (rightward in FIG. 4) past the outside flank e′ of the trailing tooth t2 in the preceding link plate 3A (in other words, the inside flank i retracts from the outside flank e′). This movement of the inside flank i can bring the outside flank e′ of the preceding plate 3A into a soft, quiet landing on the sprocket tooth T without hard colliding therewith.

Further, as soon as the about-to-mesh link plate 2 starts pivoting about the pin connection point O1 relative to the preceding link plate 3A as mentioned above, the succeeding link plate 3 is caused to start pivoting together with the about-to-mesh link plate 2 about the same pin connection point O1. However, because the inside flank i of the leading tooth t1 in the succeeding link plate 3 projects beyond the outside flank e of the trailing tooth t2 in the about-to-mesh link plate 2, it interferes with a next successive tooth T of the sprocket 7 in another buffer region S2 (depicted by hatching for clarity) to cause a frictional resistance between the two, and this frictional resistance can effectively prevent the link plate 2 from hard hitting the sprocket tooth T.

Then, once the succeeding link plate 3 has pivoted to near the phantom line position in FIG. 4 in response to rotation of the sprocket 7, the link plate 3 starts pivoting, about another pin connection point O2, shared with the about-to-mesh plate 2, toward the sprocket tooth T as shown in FIG. 5.

As a result of such a pivoting movement of the succeeding link plate 3, the inside flank i of the leading tooth t1 in the link plate 3, having so far interfered with the sprocket tooth T in the buffer region S2, is introduced deeper into between adjacent teeth of the sprocket 7 and moves forward (rightward in FIG. 4) past the outside flank e of the trailing tooth t2 in the about-to-mesh link plate 2, which can bring the outside flank e of the link plate 2 into a soft, quiet landing on the sprocket tooth T.

After completion of the pivoting movement of the succeeding link plate 3 relative to the about-to-mesh link plate 2 about the pin connection point 02 shared with the link plate 2, the two outside flanks e′ of the succeeding link plate 3 can be completely seated on the corresponding teeth T of the sprocket 7.

Then, following sets of the first- and second-type link plates 2 and 3 are sequentially brought into meshing engagement with the sprocket teeth T in the same sequence as set forth above in relation to FIGS. 4 and 5.

In the embodiment of the present invention, the teeth of the sprocket 7 are each formed into a standard involute profile, so that they come into linear contact with the outside flanks e and e′ of the first- and second-type link plates 2 and 3 when they have been completely seated thereon. Thus, the link plates 2 and 3 can mesh with the sprocket 7 at different radial positions of the sprocket teeth T depending on the profiles of their outside flanks. Namely, the radial position on the sprocket teeth T with which the chain's outside flanks mesh is allowed to vary, in the longitudinal direction of the chain 1, between the link plates 2 and 3 having the differently-profiled outside flanks. Therefore, by irregularly arranging the plates 2 and 3 with the outside flanks of two different profiles in a random mixture in the longitudinal direction of the silent chain 1, the periodicity in the meshing engagement between the plates 2, 3 and the sprocket teeth T would become non-uniform so that the meshing sounds can be prevented from resonating to get louder, with the result that the overall noise level can be minimized.

Whereas the preceding paragraphs have described the embodiment where two sets of link plates with their respective outside flanks having a straight profile and a continuous composite profile of concave and convex arcs are interlaced irregularly in the longitudinal direction of the silent chain, the outside flanks may have any other profiles than the above-mentioned as long as the link plates 2 and 3 are formed into different configurations so as to be able to mesh with the sprocket 7 at different radial positions of the sprocket teeth T depending on the profiles of their outside flanks. Further, the outside flanks may be formed into three or more different profiles rather than just two.

In another alternative, the majority of the chain's component link plates 2 and 3 may have straight outside flanks as shown in FIG. 3A, and a much smaller number of the link plates 2 and 3 with outside flanks having curved profiles, such as concave and convex arcs as shown in FIG. 3B, may be interleaved randomly in the majority of the link plates.

Furthermore, although it is desirable that the differently-configured link plates be arranged completely irregularly in the longitudinal direction of the chain in order to more effectively prevent the unwanted resonance of the meshing sounds and thereby minimize the noise level, the increase in the noise level due to the resonance in high frequency regions can be suppressed to some degree even by just arranging the different types of link plates in regular patterns that are alternately repeated in predetermined cycles.

Moreover, whereas the preferred embodiment has been described as using pairs of rocker-joint pins for connecting together the side-by-side plates, these rocker-joint pins may be replaced with round pivot pins.

In summary, in the silent chain of the present invention, the inside flanks of each about-to-mesh link plate, at the onset of meshing engagement with the sprocket teeth, interfere with and then slide along the sprocket teeth while creating a frictional resistance between the inside flanks and the sprocket teeth, and this frictional resistance can effectively damp the impact of collision that would be produced in meshing engagement with the sprocket teeth. The outside flanks of each of the link plates are shaped into any one of two or more different profiles, and the link plates having the respective outside flanks shaped into the two or more different profiles are arranged irregularly in a random mixture in the longitudinal direction of the silent chain. Thus, the link plates mesh with the sprocket at different radial positions of the sprocket teeth depending on the profiles of their outside flanks. The randomly-mixed arrangement of these differently-configured link plates can effectively randomize or disperse the generation cycles of the meshing sounds to avoid the sound resonance, thereby minimizing the overall level of the meshing sounds produced during operation of the silent chain.

Obviously, various minor changes and modifications of the present invention are possible in the light of the above teaching. It is therefore to be understood that within the scope of the appended claims the present invention may be practiced otherwise than as specifically described.

What is claimed is:

1. A silent chain for use with a sprocket comprising:
a plurality of link plates each having a pair of teeth engageable with teeth of the sprocket, the teeth of each of said link plates having a pair of symmetric outside flanks that are caused to be seated on corresponding ones of the teeth of the sprocket when the teeth of said link plate are placed in full meshing engagement with the corresponding teeth of the sprocket and a pair of symmetric inside flanks each having an arcuately convex profile protruding toward another of the inside flanks of said link plate in such a manner that a leading one of the inside flanks of said link plate interferes with one of the corresponding teeth of the sprocket at the onset of the meshing engagement between said link plate and the corresponding teeth of the sprocket; and
a plurality of pivot pins interconnecting said link plates into a longitudinally articulated chain,
wherein the outside flanks of each of said link plates are shaped into any one of two or more different profiles, and said link plates having the respective outside flanks shaped into the two or more different profiles are arranged irregularly in a random mixture in a longitudinal direction of said silent chain in such a manner that said link plates mesh with the sprocket at different radial positions of the teeth of the sprocket depending on the profiles of the outside flanks thereof.

2. A silent chain as claimed in claim 1 wherein the outside flanks of some of said link plates each have a straight profile and the outside flanks of others of said link plates each have a composite profile of concave and convex arcs.
